(19) United States
(12) Patent Application Publication
(10) Pub. No.: US 2026/0180057 A1
(43) Pub. Date: Jun. 25, 2026

(54) BATTERY CELL ASSEMBLY OF LITHIUM SECONDARY BATTERIES

(71) Applicant: ENERTECH INTERNATIONAL, INC., Chungju-si (KR)

(72) Inventors: Sang Hyun NAM, Chungju-si (KR); Dae Chun SONG, Chungju-si (KR)

(21) Appl. No.: 18/836,337

(22) PCT Filed: Oct. 11, 2023
(86) PCT No.: PCT/KR2023/015583

§ 371 Date: Aug. 6, 2024

(30) Foreign Application Priority Data
Dec. 2, 2022 (KR) 10-2022-0166827

(51) Int. Cl. H01M 10/613

(52) U.S. Cl. CPC H01M 10/613

(57) ABSTRACT

Provided is a battery cell assembly of lithium secondary batteries, which, by reducing the size of the battery module of lithium secondary batteries as much as possible, further minimizes the size and weight of the battery module. The battery cell assembly of lithium secondary batteries includes: a rectangular battery cell; an edge frame, surrounding side surface edges of the battery cell and both terminal portions of the battery cell; and screw coupling holes, into which fixing screws are fitted at rectangular corners of the edge frame. The battery cell has concave grooves formed in the rectangular corners thereof, and portions of screw assembly holes provided in the rectangular corners of the edge frame are positioned in respective concave grooves so as to reduce the length of the battery cell assembly in the longitudinal direction.

### TECHNICAL FIELD

The present invention relates to a battery cell assembly of a secondary lithium battery, more specifically to a battery cell assembly of a secondary lithium battery that is capable of improving configurations of corners of a battery cell and an edge frame for wrapping around the battery cell, thereby reducing the size of a battery module composed of multiple battery cells assembled together and rapidly emitting the heat generated from the secondary lithium battery.

### BACKGROUND ART

As technologies for electric vehicles and energy storage devices have been developed and demands for them have increased, recently, demands for secondary batteries are drastically increasing, and among the secondary batteries, secondary lithium batteries are widely used as energy sources having high energy densities and high operating voltages and excellent life cycle characteristics, and the secondary lithium batteries are suggested as alternative solutions that are capable of solving problems such as environmental pollution and global warming due to gasoline and diesel cars using fossil fuels.

In middle and large sized devices such as electric vehicles and energy storage devices wherein high outputs and large capacities are needed, a battery module having multiple battery cells electrically connected to one another is used, and as the size and weight of the battery module has a direct relation with accommodation spaces and outputs of the corresponding middle and large sized devices, many manufacturers try to make a compact and lightweight battery module ensuring a high output.

Further, there is a need to perfectly solve problems such as performance lowering and usage period shortening with the battery module due to high heat generated from the battery module in the process of charging and discharging the secondary lithium battery.

FIG. 1 is a plan view showing a battery cell assembly 10 of a secondary lithium battery used for an electric vehicle or energy storage device, wherein a battery cell 11 and an edge frame 13 are assembled together. In this case, the edge frame 13 is made of a synthetic resin as an insulating material and is assembled to the battery cell 11 in such a way as to wrap around both sides and both terminal portions 12 of the battery cell 11.

Further, the edge frame 13 has screw-coupling holes 14 formed on four corners thereof in such a way as to fit fixing screws thereto so that the edge frame 13 is kept in position when a plurality of battery cells 11 are stacked side by side.

In the case of the conventional pouch type secondary lithium battery, as the battery cell 11 basically has the shape of a simple rectangle, there is no problem in making or using the battery cell 11, but, because the screw-coupling holes 13 formed on the four corners of the edge frame 13 are spaced apart from the ends of the four corners of the battery cell 11 outwards by a given distance, a length L1 from one end of the battery cell 11 to the central position of each screw-coupling hole 14 extends, thereby disadvantageously causing the entire longitudinal length L2 of the battery cell assembly 10 to increase.

Therefore, if the plurality of battery cells 11 are stacked side by side and electrically connected to constitute the battery module, the entire size and weight of the battery module increase, thereby having bad influences on accommodation spaces and outputs of middle and large sized devices using the battery module. Therefore, there is a definite need to develop a battery module cell that is compact and lightweight.

Besides, the edge frame 13 is configured to wrap around both sides of the battery cell 11, so that the heat generated from the battery cell 11 in the process of charging and discharging the secondary lithium battery is not rapidly emitted due to the edge frame 13, thereby lowering the performance of the battery module due to high heat generated when the secondary lithium battery is charged and discharged and shortening the usage period of the secondary lithium battery.

### DISCLOSURE OF THE INVENTION

### Technical Problems

Accordingly, the present invention has been made in view of the above-mentioned problems occurring in the related art, and it is an object of the present invention to provide a battery cell assembly of a secondary lithium battery that is capable of reducing a size of a battery module of the secondary lithium battery to the maximum, so that the battery module can be compact and lightweight, thereby allowing electric vehicles and energy storage devices to be optimized in space and density when their components are put together, while enhancing their output.

It is another object of the present invention to provide a battery cell assembly of a secondary lithium battery that is capable of allowing heat generated from a battery cell to be rapidly emitted in a process of charging and discharging the secondary lithium battery, thereby minimizing heat generation from the inside of the battery module, improving the performance of the secondary battery, and extending the period of use of the secondary battery.

### Technical Solutions

To accomplish the above-mentioned objects, according to the present invention, there is provided a battery cell assembly of a secondary lithium battery, including: a rectangular battery cell; an edge frame for wrapping around one side and both terminal portions of the battery cell and having screw-coupling holes formed on four corners thereof in such a way to fit fixing screws thereto, wherein the battery cell has concave grooves formed on four corners thereof in such a way to allow portions of the screw-coupling holes formed on the four corners of the edge frame to be located thereinto to thus reduce a longitudinal length of the battery cell assembly.

According to the present invention, further, the edge frame may include both-end edges for wrapping around both terminal portions of the battery cell and a single side edge for wrapping around one side of the battery cell.

According to the present invention, furthermore, the side edge may be detachably coupled to the both-end edges of the edge frame in such a way as to wrap selectively around one side or the other side of the battery cell.

According to the present invention, further, a detachable structure of the side edge from the both-end edges may include first detachable protrusions and second detachable protrusions protruding from tops and bottoms of both connection ends of the side edge, and first detachable grooves and second detachable grooves formed on both connection ends of the edge frame facing both connection ends of the side edge in such a way as to fit the first detachable protrusions and second detachable protrusions thereto.

### Advantageous Effects of the Invention

According to the present invention, the battery cell assembly is configured to have the concave grooves formed on the four corners of the battery cell in such a way as to locate some of the screw-coupling holes of the edge frame to be located inside the concave grooves, so that the entire longitudinal length of the battery cell assembly is reduced by lengths with which some of the screw-coupling holes are located inside the concave grooves, and the battery module composed of the plurality of battery cell assemblies stacked side by side is decreased in size, so that the battery module can be more compact and lightweight, thereby allowing the electric vehicle and the energy storage device to be optimized in space and density when their components are put together, while enhancing their output.

According to the present invention, further, the battery cell assembly is configured to allow the side edge of the edge frame for wrapping around one side of the battery cell to be detachably coupled to the both-end edges so that there is no side edge for wrapping around the other side of the battery cell from which heat of the battery cell is emitted, thereby rapidly emitting the heat generated from the battery cell to minimize heat generation from the inside of the battery module, improving the performance of the secondary battery, and extending the usage period of the secondary battery.

### BRIEF DESCRIPTION OF DRAWINGS

FIG. 1 is a plan view showing a conventional battery cell assembly.

FIG. 2 is a perspective view showing a battery cell assembly according to the present invention.

FIG. 3 is an exploded perspective view showing the battery cell assembly according to the present invention.

FIG. 4 is a plan view showing a battery cell and an edge frame of the battery cell assembly according to the present invention.

FIG. 5 is an enlarged view showing a portion A of FIG. 4.

FIG. 6 is an enlarged view showing a portion B of FIG. 4.

FIG. 7 is a separate perspective view showing a detachable structure of a side edge and a both-end edge shown in FIG. 6.

FIG. 8 is a plan view showing another example of the side edge of the battery cell assembly according to the present invention.

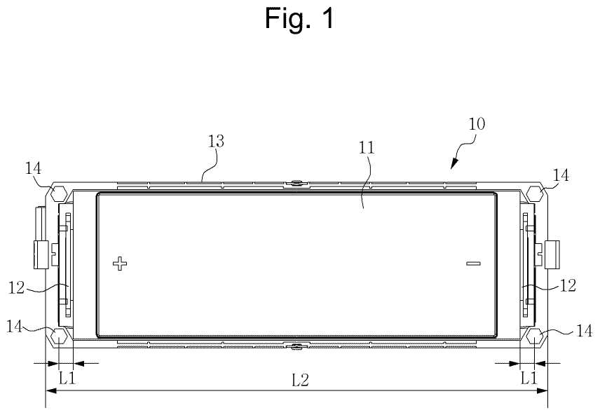

### BEST MODE FOR INVENTION

Hereinafter, an explanation of a battery cell assembly of a secondary lithium battery according to the present invention will be given in detail with reference to the accompanying drawings.

### Mode for Invention

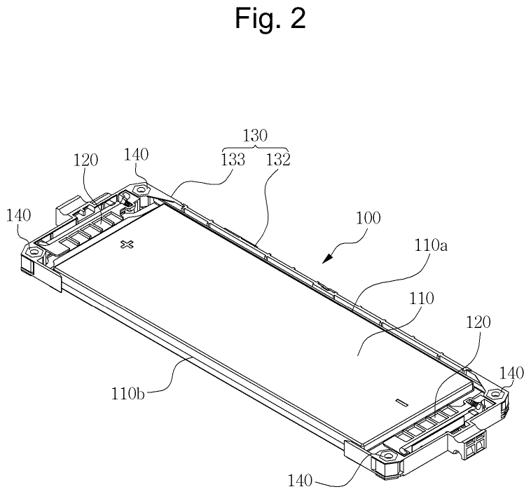

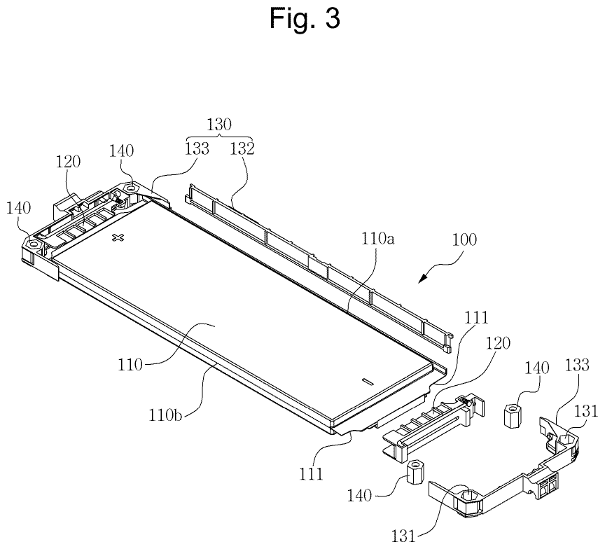

FIGS. 2 and 3 are a perspective and separate perspective view showing a battery cell assembly of a secondary lithium battery according to the present invention, and as shown, a battery cell assembly 100 includes a rectangular battery cell 110 and terminal portions 120 located on both ends of the battery cell 110 in a longitudinal direction of the battery cell 110.

An edge frame 130 is wrapped around one side of the battery cell 110 and both terminal portions 120 of the battery cell 110, and the edge frame 130 is made of an insulating material such as a synthetic resin and has screw-coupling holes 131 formed on four corners thereof in such a way as to fit fixing screws 140 thereto.

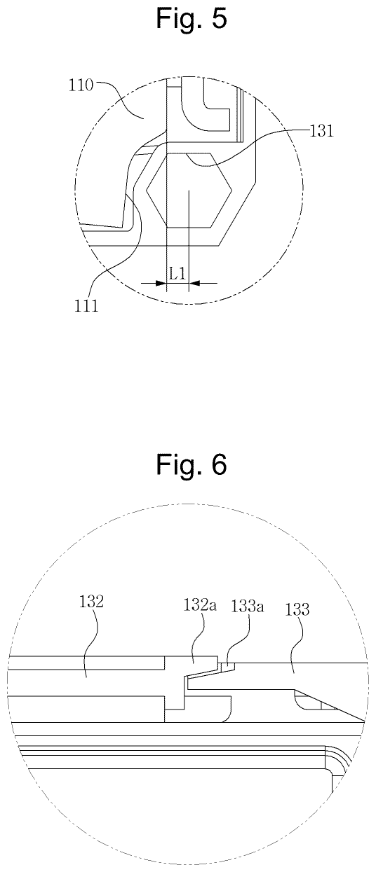

As shown in FIGS. 3 to 5, in this case, the battery cell assembly 100 according to the present invention is configured to improve the coupling structure between the battery cell 110 and the edge frame 130 so that an entire longitudinal length L2 thereof can be reduced. To do this, concave grooves 111 are formed on the four corners of the battery cell 110, and accordingly, portions of the screw-coupling holes 131 formed on the four corners of the edge frame 130 are located inside the concave grooves 111.

As a result, a length L1 from one end of the battery cell 110 to the center of each screw-coupling hole 131 is reduced by positioning the screw-coupling hole 131 inside the corresponding concave groove 111, thereby allowing the entire longitudinal length L2 of the battery cell assembly 100 to be reduced by the moving lengths of the screw-coupling holes 131 to the concave grooves 111 on both sides of the battery cell assembly 100.

Like this, if the entire longitudinal length L2 of the battery cell assembly 100 is reduced, a battery module, which is composed of a plurality of battery cell assemblies 100 side by side stacked, is decreased in size, thereby being compact and lightweight. Further, an electric vehicle and energy storage device in which the battery module is used are optimized in space and density, and their output is enhanced.

Referring back to FIGS. 2 and 3, the edge frame 130 of the battery cell assembly 100 according to the present invention includes both-end edges 133 for wrapping around both terminal portions 120 of the battery cell 110 and a single side edge 132 for wrapping around one side 110a of the battery cell 110 in such a way as to be detachably coupled to the both-end edges 133, and there is no side edge 132 on the other side 110b of the battery cell 110.

Therefore, heat generated from the battery cell 110 is rapidly emitted through the other side 110b from which the side edge 132 is removed, so that heat generation from the inside of the battery module is minimized, thereby improving the performance of the secondary battery and extending the usage period of the secondary battery.

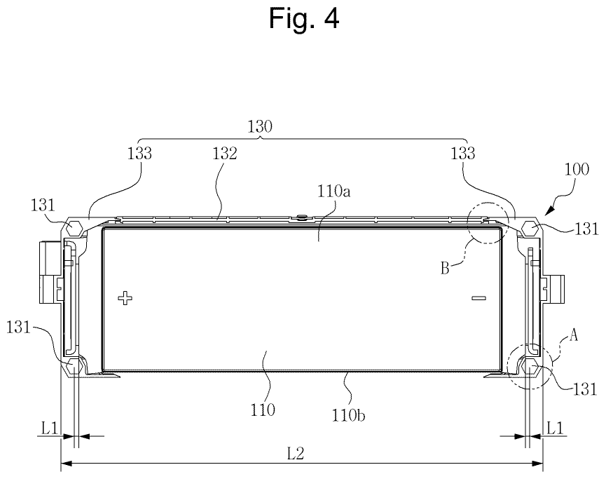

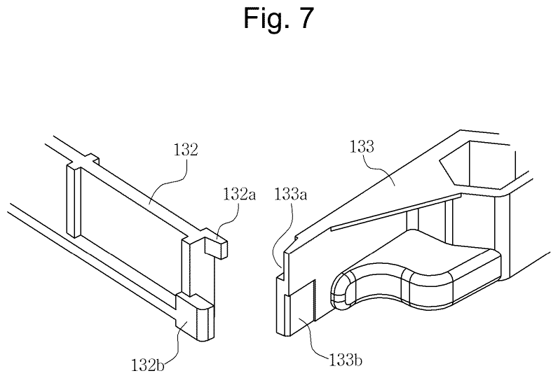

Further, the single side edge 132 wraps around either one side 110a or the other side 110b of the battery cell 110, and as shown in FIGS. 4, 6, and 7, a detachable structure of the side edge 132 from the both-end edges 133 includes first detachable protrusions 132a and second detachable protrusions 132b protruding from tops and bottoms of both connection ends of the side edge 132 and first detachable grooves 133a and second detachable grooves 133b formed on both connection ends of the both-end edges 133 facing both connection ends of the side edge 132 in such a way as to fit the first detachable protrusions 132a and second detachable protrusions 132b thereto.

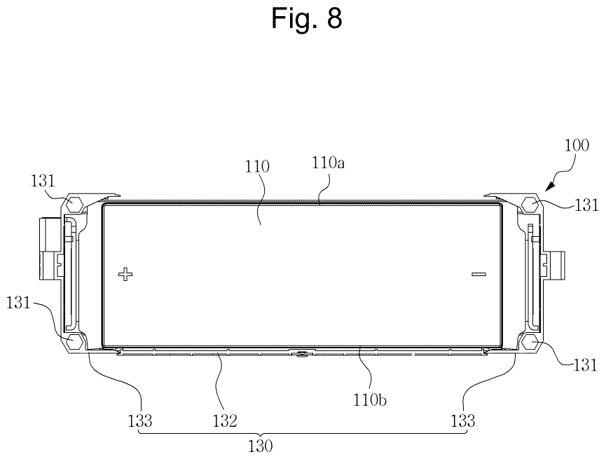

According to the detachable structure of the side edge 132, as shown in FIG. 4, if the side edge 132 is coupled to the both-end edges 133 of the edge frame 130 to wrap around one side 110a of the battery cell 110, the heat generated from the battery cell 110 is emitted through the other side 110b of the battery cell 110, and as shown in FIG. 8, if the side edge 132 is coupled to the both-end edges 133 of the edge frame 130 to wrap around the other side 110b of the battery cell 110, the heat generated from the battery cell 110 is emitted through one side 110a of the battery cell 110.

Therefore, in the case of an electric vehicle and energy storage device in which the battery module composed of the plurality of battery cell assemblies 100 stacked side by side is used, compatibility capable of selecting a position where the side edge 132 is removed according to a heat emission direction is provided to improve usage effectiveness thereof.

As described above, the optimized embodiment of the present invention has been disclosed with reference to the attached drawings. Terms used in this application are used to only describe specific exemplary embodiments and are not intended to restrict the present invention. Therefore, it should be understood by those of ordinary skill in the art that the present invention is not limited by the embodiments as will be discussed later and has all modifications in the technical spirit and scope of the present invention. That is, the present invention may be freely modified by those of ordinary skill in the art through addition, change, and deletion of the components thereof within the scope of the invention limited by the claims appended hereto, and the modifications may be within the scope of the claims.

### Industrial Applicability

According to the present invention, the battery cell assembly is configured to allow the battery module to be reduced in size, thereby achieving miniaturization and lightweight of the battery module, and configured to allow the electric vehicle and the energy storage device to be optimized in space and density and improved in output.

1. A battery cell assembly of a secondary lithium battery, including: a rectangular battery cell; and an edge frame for wrapping around one side and both terminal portions of the battery cell and having screw-coupling holes formed on four corners thereof in such a way as to fit fixing screws thereto,
wherein the battery cell has concave grooves formed on four corners thereof in such a way as to allow portions of the screw-coupling holes formed on the four corners of the edge frame to be located thereinto to thus reduce a longitudinal length of the battery cell assembly;
the edge frame comprises both-end edges for wrapping around both terminal portions of the battery cell and a single side edge for wrapping around one side of the battery cell;
the side edge is detachably coupled to the both-end edges of the edge frame in such a way as to wrap selectively around one side or the other side of the battery cell according to a heat emission direction; and
a detachable structure of the side edge from the both-end edges comprises first detachable protrusions and second detachable protrusions protruding from tops and bottoms of both connection ends of the side edge and first detachable grooves and second detachable grooves formed on both connection ends of the both-end edges facing both connection ends of the side edge in such a way as to fit the first detachable protrusions and second detachable protrusions thereto.
